(19) United States
(12) Patent Application Publication
(10) Pub. No.: US 2012/0228174 A1
(43) Pub. Date: Sep. 13, 2012

(54) TRAY WITH FOLDABLE SUPPORT

(75) Inventors: Kai Wegener, Munchen (DE); Klaus Dittmaier, Zellingen (DE)

(73) Assignee: KRONES AG, Neutraubling (DE)

(21) Appl. No.: 13/414,168

(22) Filed: Mar. 7, 2012

(30) Foreign Application Priority Data
Mar. 11, 2011 (DE) 102011005396.4

(51) Int. Cl. B65D 1/34; B65G 47/00

(52) U.S. Cl. 206/427; 206/557; 206/559

(57) ABSTRACT

A tray for transporting goods, in particular beverage packs, on a transport medium with a basic element with a support surface for the transport goods in which at the basic element, a foldable support for supporting the transport goods is attached.

### CROSS-REFERENCE TO RELATED APPLICATION

The present application claims the benefit of priority to German Patent Application 102011005396.4, filed Mar. 11, 2011, which is incorporated herein by reference in its entirety.

### TECHNICAL FIELD

The invention relates to a tray for the transport of transport goods on a transport medium, for example a conveying belt or a roller conveyor.

### BACKGROUND

Trays are containers or conveyor means which are employed in the transport of objects to make the transport properties of objects independent of the properties of the conveyor media, such as belt conveyors. In prior art, they often have a flat design and comprise a rim to prevent conveyed objects from slipping off. The fields of application of trays include, for example, in the beverage industry, the transport of beverage packs or the like, but also applications at the airport where objects are transported through an X-ray apparatus on a conveyor belt for screening.

A typical problem with trays of prior art arises when objects are transported that have a high center of gravity. If they are accelerated or transported jerkingly, they tend to fall over or even fall off the tray, which disturbs the course of transport.

Some optional objects underlying the trays of the present application include preferably to eliminate this problem and optionally also to simultaneously obtain advantageous properties of a tray, for example a space-saving way of storing the tray.

### SUMMARY

These and other objects may be achieved by a tray according to at least one or more arrangements of the present disclosure.

In one aspect of the invention, a tray is provided according to claim 1. Advantageous embodiments of the invention are disclosed in the dependant claims.

Further aspects of possible embodiments will become clear with reference to the Figures.

### BRIEF DESCRIPTION OF THE DRAWINGS

FIGS. 1 a-d show embodiments of the disclosure;

FIGS. 2 a-b show an additional embodiment of the disclosure;

FIGS. 3 a-b show stacks of several similar trays designed according to embodiments of the disclosure;

FIGS. 4 a-b show further possible embodiments of the disclosure; and

FIGS. 5 a-d show a possible use for a tray in accordance with the disclosure.

### DETAILED DESCRIPTION

In a tray according to some preferred aspects of the disclosure, a support is fixed to the basic element of the tray in a foldable manner. The height of the support can be selected corresponding to the properties of the transported objects.

By the foldable support, the transported goods lying on the support surface can be supported. By this, they can be stabilized, for example in case of sudden accelerations or a jerking motion. Thus, many troubles in the course of transport due to tipped over transport goods or transport goods that have fallen off the trays can be avoided. A foldable support is mainly interesting in case of transport goods having high centers of gravity as its height in the unfolded state can reach to the height of the center of gravity or even higher. Therefore, it can also stabilize transport goods having high centers of gravity. Since it can be folded after transport, disadvantages that can arise in storage due to a high support can be avoided.

A space-saving storage of a tray in accordance with the disclosure is facilitated or enabled by the support being foldable when the trays are not being required. A tray with a folded support often does not need any more storage volume than a tray without support. Thus, stacking of several similar trays can also be enabled.

The term basic element designates the basic element of the tray without support or any other optional parts which rests with one side on the transport medium or a support medium and which has, on the side opposite the transport or support medium, a surface on which the transport goods rest and which is referred to as support surface.

In a preferred embodiment, the support surface is embodied to be inclined towards the support. By this inclination, one can take into account the special properties of the transport goods, requirements due to the transport medium or path, and/or requirements during loading and unloading. In the employed tray, the inclination of the support surface can be adapted to requirements of the typically transported object. It can have an angle of inclination within a range of the values between a lower limit of one of the values of (just) above 0°, or 10°, 20°, 30°, 40°, and an upper limit of one of the values of 10°, 20°, 30°, 40° and 45°. It may make sense to hold available trays with support surfaces inclined in different ways for transport objects of different kinds. Transport goods can also be stabilized by the inclination in the direction opposite to the support. For example, by the inclination, it will, in case of instability, move towards the support and lie stable there as soon as it has reached a position in contact with the support.

In another preferred embodiment, openings and/or holes and/or recesses are formed in the support. These can facilitate the loading and unloading of the tray by permitting, for example, the use of implements for loading and unloading also from the direction of the support.

In one embodiment, the support can be provided such that it includes an angle with the support surface between 45° and 135°, or between 60° and 120°, or between 75° and 105°, or an angle of approx. 90°. At an angle of about 90°, transport goods, e.g. a beverage pack, whose side limits include an angle of approx. 90° with the footprint, can be optimally supported. For other transport objects whose side faces include an angle other than about 90°, a different angle of the support can be selected accordingly.

In another embodiment, the tray comprises one, two, three, four or more surfaces or points at the upper side of the basic element and surfaces or points corresponding to these surfaces or these points on the bottom side of the basic element. These surfaces or points can facilitate stacking of several trays of a similar design as they can here serve as support surfaces or points. Here, the surfaces or points of the upper side come into contact with the corresponding surfaces or points of the bottom side.

A further embodiment includes that at one, two, three, four or more surfaces or points at the upper side of the basic element, at least one elevation or recess is attached or provided. At the respective corresponding bottom sides of the tray, for each elevation or recess, one matching recess or elevation is provided as counterpart to the elevation or recess. Stacking of several similar trays in accordance with the disclosure can thus be stabilized by the elevations that lie in the recesses when stacked. The tray is thus prevented from slipping off the stack, or this is at least less probable compared to the embodiment without elevation/recess. If the elevations are embodied at the bottom side of the tray, these can additionally serve a stable standing of the tray on some conveyor media. In other situations, it can be advantageous to provide the elevations on the upper side of the tray to increase the stability of the tray on another conveyor medium.

In another preferred embodiment, an indentation is embodied on the bottom side of the tray. This indentation can be used to receive parts of the folded tray projecting beyond the upper periphery of the basic element when several similar trays are stacked. Here and in the following, the term upper periphery of the basic element is to be understood as a fictitious horizontal surface which extends through the highest point of the basic element without taking into account possibly existing elevations for stabilizing the stacking when it rests on a horizontal conveyor or support medium in the working position. The upper periphery comprises the surface area which corresponds to the surface of the medium covered by the tray, seen vertically from above, on which the tray is standing.

In another embodiment, the tray is designed such that the folded support comes to lie on the basic element such that parts of it or the complete support are lying under the upper periphery. In case of the support lying completely under the upper periphery of the basic element, this can permit to stack several trays in accordance with the disclosure without any further indentation being required in the bottom side of the tray. In case of the support only partially lying under the upper periphery of the basic element, this can facilitate a stacking of several similar trays as here only the projecting parts must be received by an indentation in the bottom side of the tray lying above it. Thereby, this indentation at the bottom side of the tray can be smaller. This can, among other things, also increase the stability of the tray.

In another embodiment, the basic element is designed in two parts. The two parts of the basic element are here connected with a hinge or similar means which permit a movement of the two parts of the basic element relative to each other about an axis, so that the support surface can be tilted with respect to the part of the basic element resting on the conveyor or support medium. This can facilitate loading and unloading as it is possible, for example, to bring the support surface into a horizontal position. In addition, however, this can also be employed for loading and unloading to reinforce the respective process by an inclination. One example of this is unloading the tray by dumping the transport goods by inclining the support surface.

Another embodiment includes that at one, two or three rims of the support surface, the lateral surface is flat. The lateral surface of the support surface at one side here designates the region which laterally terminates the support surface and extends to the extreme rim of the tray. If the lateral surface has a flat design, it can also be understood as portion of the support surface.

The flatness of one, two or several lateral surfaces of the support surface in particular includes that at one, two or several sides of the tray, no raised rim is provided next to the support surface which would hinder loading and unloading by pushing the transport goods from and into this direction. This can facilitate loading and unloading from and into the direction of this side or sides. If, for example, two opposite side rims of the tray are flat, this can in particular permit to push the transport goods over a tray. Another exemplary process which can be enabled thereby is loading from the one side and corresponding unloading from the other side.

In another preferred embodiment, indentations, handles, hooks or other points of application for machines are provided at the basic element, which facilitate a mechanical and/or manual transport of the trays from and onto the transport medium or another support medium and/or permit a manual or mechanical tilting of the support surface.

For tilting the support surface, indentations, handles, hooks or other points of application for machines can be advantageously arranged at the upper part of a two-part basic element for tilting the support surface. However, the support surface of a one-part basic element with provided indentations, handles, hooks or other points of application for machines can also be tilted as it is not necessary for the lowermost part of the basic element to completely rest on the transport medium.

Another embodiment includes that the support can be fixed in the folded position and/or in the unfolded position. This fixing can be accomplished, for example, by hooks, a clamp, a hinge with arrest or the like. Preferably, the support can be easily and quickly fixed, and fixing can be equally easily and quickly released.

In another embodiment, the support is attached to the basic element such that in the unfolded state, it is at least partially supported by the basic element on the side facing away from the transport goods. This can increase the stability of the support as the load can be distributed more uniformly. In addition, this can prevent the support from snapping towards the side opposite the transport goods.

Another embodiment includes that at one, two or three sides of the tray which are not secured by the foldable support, a rim raised with respect to the support surface is provided which is to prevent the transport goods from slipping off in this direction. This can additionally increase the stability of the transport objects as they can thereby also be protected from slipping off in directions which are not in the same direction as the foldable support.

In one embodiment, the basic element of the tray is made of suited plastics. This can be advantageous as plastics are inexpensive, can be easily brought into any shape, are of low weight and sufficiently stable for the transport of objects, in particular beverage packs. The support can also be made of suited plastics. This can moreover have the advantage that a tray of plastics with a plastic support cannot be easily damaged by wetness.

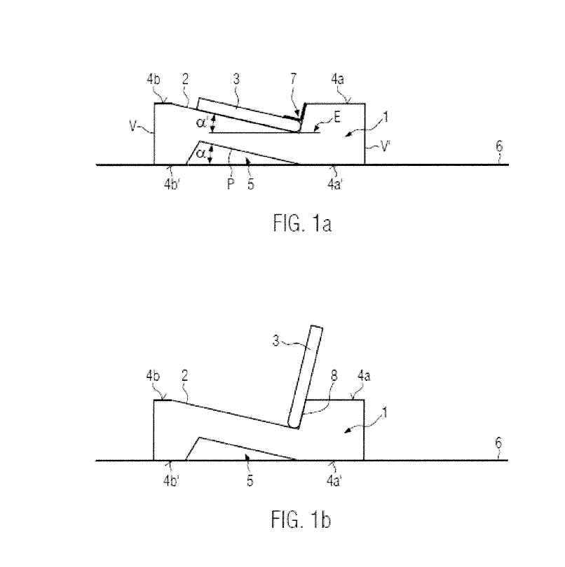

Turning now to the exemplary arrangements shown in the drawings, FIGS. 1a to 1c show first embodiments of the disclosure.

FIG. 1a shows a tray according to a first embodiment. The represented tray has a basic element 1 with a support surface 2 embodied to be inclined in this example. It comprises a foldable support 3 which is here represented in the folded state. The support 3 in accordance with the disclosure can rest on the basic element 1, as it is represented here, such that parts of it are lying under the upper periphery of the basic element 1. Moreover, the tray here comprises, by way of example, an indentation 5 in the bottom side of the tray for receiving projecting parts of the support 3 of a further similar tray in case several similar trays are stacked. On the upper side and the bottom side of the tray, one can see in this example horizontally embodied surfaces 4a, 4b, 4a′, 4b′ by which stacking of several trays in accordance with the disclosure is permitted. In this case, two surfaces 4a, 4b are here embodied at the upper side and two corresponding surfaces 4a′, 4b′ at the bottom side. Other numbers of surfaces or points can also be embodied in trays in accordance with the disclosure (not shown here).

As can be taken from FIG. 1a, a tray in accordance with the disclosure can comprise vertical surfaces V, V′ at the sides of the tray which result in a clear boundary of the tray and can also contribute to a space-saving stackability of several similar trays as several trays form stacks with vertical, smooth walls.

In addition, in possible embodiments, as is shown by way of example in FIG. 1, the inclination of the support surface 2 can be selected (approximately) to correspond to the inclination of a surface P in the indentation 5 of the bottom side of the tray, wherein the support surface 2 extends in parallel to the surface P of the indentation 5. By this, the angle α between the transport medium 6 and the inclination of the indentation and the angle α′ between a fictitious plane E in parallel to the transport medium and the support surface 2 are identical. A different inclination of the support surface 2 and the inclinations of the indentation 5 is also possible (not shown here) and can dependently on the embodiment of the support 3 be advantageous, if several similar trays are to be stacked.

The tray can, as any other embodiment of a tray in accordance with the disclosure, be made, for example, by plastic injection molding and therefore be of a very low weight. In this embodiment shown in FIG. 1, the sides of the support surface not limited by the support 3 in the unfolded state are by way of example designed to be flat, so that loading and unloading from three directions is permitted. In the embodiment shown in FIG. 1a, the foldable support is mounted with a hinge 7. Any other connection means permitting a relative movement between the support 3 and the support surface 2 about an axis can also be used (not shown here).

In the situation shown in FIG. 1, the tray is located on a transport medium 6, for example a conveyor belt or a roller conveyor section.

FIG. 1b shows the tray of FIG. 1a with an unfolded support 3 which in the unfolded state includes an angle of 90° with the support surface 2. Here, one can easily see that in the selected example, the inclination of the support surface 2 extends towards the support 3. If, for example, transport goods are now placed onto the support surface 2, they slide towards the support 3 due to the inclination of the support surface 2 and then lie stably. In further embodiments, the support surface 2 can also be arranged without inclination (not shown in FIG. 1b).

The unfolded support 3 can be simultaneously supported, as in this example, by a portion of the basic element 8 which is located on the side opposite the transport goods. This portion 8 can be arranged to be approximately perpendicular to the support surface 2 which then also leads to an approximately vertical arrangement of the support 3 in the unfolded position. An arrangement of the support 3 at a different angle between the support surface 2 and the support 3 can also be selected (not shown here).

FIG. 1c shows another embodiment of the disclosure in which openings 9 are provided in the unfolded support 3. These can be, for example, of assistance for loading and unloading as they permit access to the transport goods through rods or other implements for loading and unloading also from the direction from which access would be otherwise prevented by the support 3. The openings 9 can be adapted in shape and size to the requirements due to the transported objects or the implements for loading and unloading.

FIG. 1d shows a tray according to a further embodiment of the disclosure. Here, the tray comprises a horizontal support surface 2 which is limited on the side opposite to the support 3 by a raised rim 10 which is to prevent the transport goods from slipping off in this direction. Simultaneously, the two other side faces of the support surface 2 are designed to be flat, so that loading and unloading from these directions by pushing the transport goods from the side is permitted. In other embodiments, the side of the support surface 2 opposite the support 3, too, can be designed to be flat, and/or the two other side faces of the support surface can be embodied with a rim (not shown). The foldable support is connected with the basic element by a hinge 7. The hinge can also be replaced by other means which permit a movement of the support 3 relative to the support surface 2 about an axis and/or can be arrestable (not visible here).

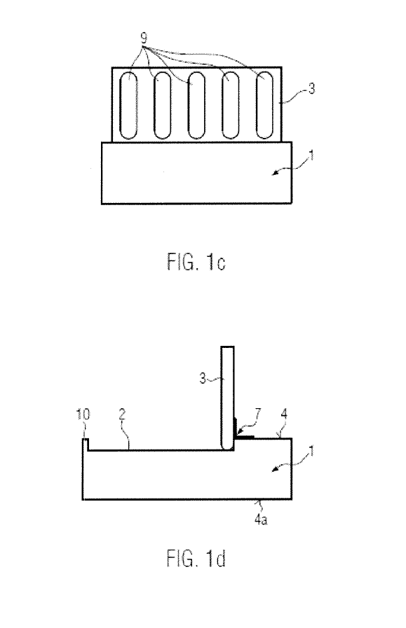

FIG. 2 shows another embodiment of the disclosure in which the basic element 1 is embodied in two parts. The two parts 1a, 1b are here connected, by way of example, by a hinge 11. Any other connection by means which permit a movement of the two parts of the basic element 1a, 1b relative to each other about an axis, however, can be used instead of the hinge 11 (here not shown). In addition, and as is shown here, the hinge 11 can be arranged on a part of the lower part of the basic element 1b tapering towards the upper part of the basic element 1a. This can facilitate tilting about the hinge axis.

One can also see in FIG. 2 that between the two basic elements 1a, 1b on the tray side which in this example extends in parallel opposite the side connected by a hinge 11, a broad surface B (with an extension of more than 10% or 20% of the extension of the basic part, both measured in the direction transverse to the hinge or a corresponding axis of revolution of the two parts) of the upper part of the basic element 1a can be present which rests on the lower part of the basic element 1b and which can lead to the load being, during transport in the basic position of the tray, distributed as uniformly as possible on the surface B′ of the lower part of the basic element 1b and thus on the lower part of the basic element 1b, and also on the conveyor medium. Preferably, the two surfaces B and B′ are arranged horizontally.

In case of a two-part basic element 1, the support surface 2 and the surface P of the indentation 5 can be arranged in parallel. In a preferred embodiment, they are not arranged in parallel because by the two parts of the basic element 1a, 1b, boundaries between the basic elements are also present which must extend in space such that the parts of the basic element 1a and 1b can come to lie on each other in a suited manner.

A possible embodiment which is visible in FIG. 2a comprises a parallel arrangement of the support surface 2 and the surface P′ which represents a periphery for the upper part of the basic element 2a. In addition, and as is shown by way of example in FIG. 2a, a portion P″ of the surface of the lower part of the basic element 1b and the surface P of the indentation 5 of the lower basic element can extend approximately in parallel. Here, as also in other embodiments, the inclination of the surface P′ is preferably greater than or equal to the inclination of the surface P″, so that the two surfaces P′ and P″ do not lie upon each other, have a constant distance or lie upon each other in an exactly matching manner, and no distance that could lead to instability is present between the two parts of the basic element 1a, 1b. By the above described arrangement, the weight transfer from the upper basic element 1a to the lower basic element 1b can be partially accomplished via the surfaces B and B′.

There are also embodiments of the disclosure in which no, two, three or four of the inclinations of the surfaces 2, P, P′ and P″ are parallel. The inclination of the surface P′ is preferably greater than the inclination of the surface P″, so that these two surfaces do not lie upon each other, have a constant distance, or lie upon each other in an exactly matching manner and no distance is present between the two parts of the basic element 1a, 1b. By this, the weight transfer from the upper basic element 1a to the lower basic element 1b can be partially accomplished via the surfaces B and B′. However, it is also possible that in some embodiments, the inclination of the surface P″ is greater than the inclination of the surface P′, and the stability of the tray is nevertheless maintained.

In FIG. 2a, one can see a tray with a two-part basic element 1a, 1b in the basic position which is assumed during transport and maintained as long as no force acts on the upper part of the basic element 1a.

FIG. 2b shows the tray when the upper part of the basic element 1a is in a tilted position. The support surface 2 is here tilted with respect to the basic position and in this example brought into a horizontal position. This position can be advantageous when loading the tray as it can permit to push the transport goods horizontally onto the tray.

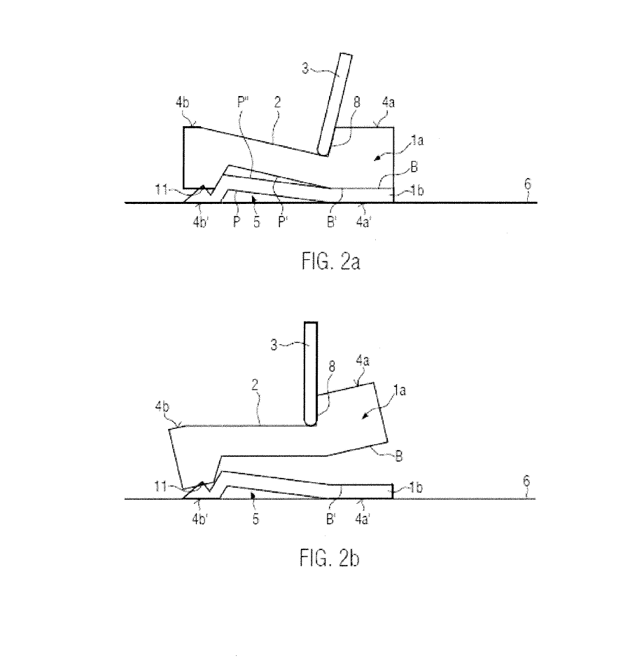

FIG. 3 shows the stacking of several trays according to the embodiments of FIGS. 1 and 2 of the disclosure.

Here, FIG. 3a shows a stack of several trays described in FIGS. 1a and 1b. The indentations in the bottom side 5 of each tray can receive the parts of the respective underlying support 3 projecting beyond the upper periphery. In addition, one can see that also parts of the support 3 come to lie in this embodiment under the upper periphery of the basic element 1. One can furthermore see corresponding surfaces, here embodied horizontally, at the upper and bottom sides 4a, 4b, 4a′, 4b′ of each tray which facilitates stacking.

FIG. 3b shows a stack of several trays described in FIG. 2. FIG. 2 also shows the advantage of surfaces 4a, 4b, 4a′, 4b′ at the upper and bottom sides of the tray which are here embodied to be horizontal.

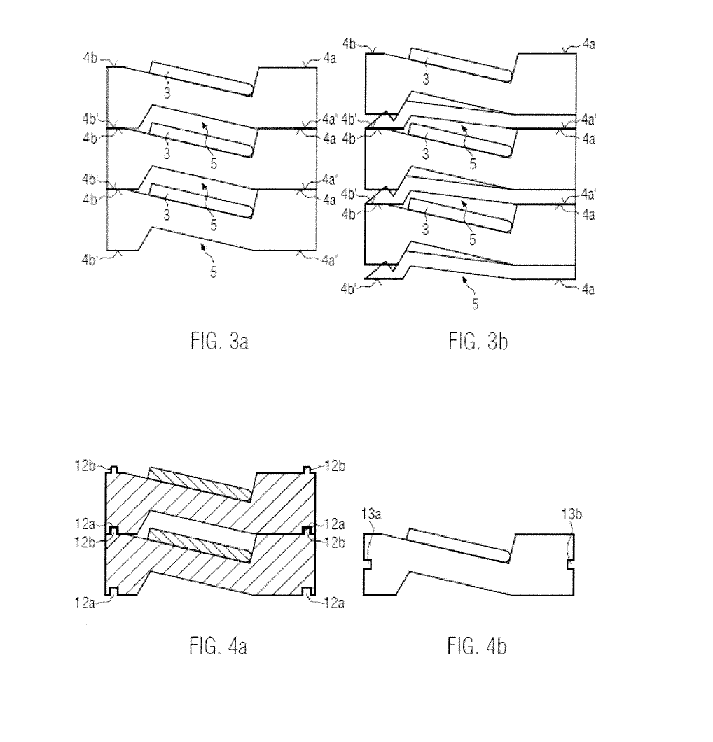

FIG. 4a shows a vertical cross-section through the tray in a direction perpendicular to the support surface. The trays are in this case manufactured such that stacks of similar trays are additionally stabilized. While in this case, recesses 12a are embodied on the surfaces of the bottom side of the tray, on the surfaces on the upper periphery of the tray, elevations 12b are embodied which fit into indentations and thus stabilize the stacks of similar trays.

FIG. 4b shows a possible embodiment with indentations 13a, 13b suited as handles which facilitate a manual transport of the tray from and onto the conveyor or support medium: by the indentation 13a and a corresponding indentation 13b provided on the opposite side, the tray has points of application for the manual transport of the tray from and onto the conveyor or support medium. Instead of indentations, handles of other kinds, hooks or other points of application for machines could also be used for this (not shown).

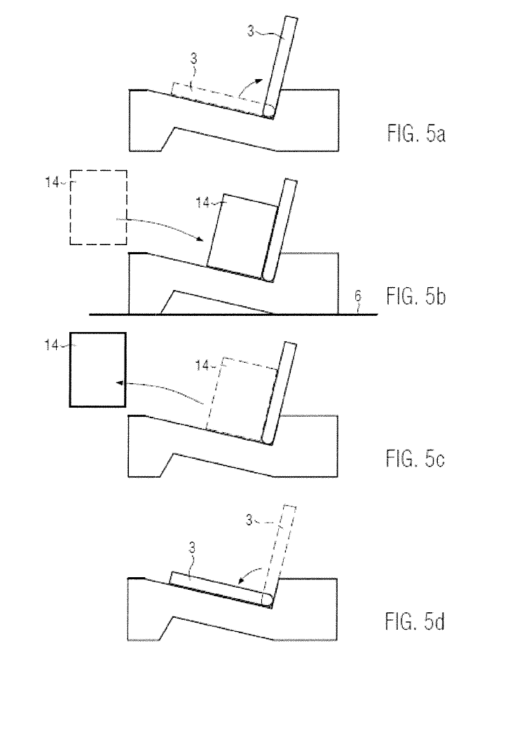

FIG. 5 shows steps of an exemplary course of transport using a tray in accordance with the disclosure.

Here, FIG. 5a shows how the support 3 is unfolded in a first step.

In FIG. 5b, the provided transport goods 14 are transferred onto the tray in a second step and can then be transported on the tray on a transport medium 6. Loading can also be facilitated by tilting the support surface during loading (not shown here).

FIG. 5c shows the step of unloading the tray. Here, too, a possible tilting of the support surface is not shown.

In FIG. 5d, the folding of the support 3 is shown in a next step.

Subsequently, the individual trays in accordance with the disclosure can be stacked one upon the other for storage, as is represented, for example, in FIG. 3a.

Numerous modifications to the trays disclosed herein will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

1. A tray for the transport of transport goods on a transport medium comprising,
a basic element with a support surface for the transport goods, and
a foldable support for supporting the goods, wherein the foldable support is attached to the basic element.

2. A tray according to claim 1, wherein the support surface is embodied to be inclined towards the support.

3. A tray according to claim 1, wherein openings and/or holes and/or recesses are formed in the support.

4. A tray according to claim 1, wherein the support includes an angle with the support surface between 45° and 135°.

5. A tray according to claim 1, wherein one or more surfaces or points are embodied at an upper side of the tray, and corresponding surfaces or points are embodied at a bottom side of the tray.

6. A tray according to claim 1, wherein one more surfaces or points are embodied at an upper side of the basic element, at least one elevation or recess is provided at the surfaces or points, and at corresponding surface(s) or point(s) on a bottom side of the basic element, matching recesses or elevations are provided as counterparts to the respective elevations or recesses on the surfaces on the upper side.

7. A tray according to claim 1, wherein at a bottom side of the tray, an indentation is formed.

8. A tray according to claim 1, wherein the foldable support when in a folded position comes to lie on the basic element such that at least some portion of the foldable support lies underneath an upper periphery of the basic element.

9. A tray according to claim 1, wherein the basic element is embodied in two parts, and the two parts are connected by a hinge, such that the support surface can be tilted with respect to a part of the basic element lying on the transport medium or another support surface.

10. A tray according to claim 1, wherein at one, two, or three sides of the tray, a rim surface is embodied to be flat, so that loading and unloading is permitted via these sides.

11. A tray according to claim 1, wherein handles, indentations, hooks, or points of application for machines are provided at the basic element, which facilitate a manual or mechanical tilting of the support surface.

12. A tray according to claim 1, wherein the foldable support can be fixed in a folded position and/or an unfolded position.

13. A tray according to claim 1, wherein the foldable support is attached to the basic element such that the foldable support is at least partially supported by the basic element on a side facing away from the transport goods.

14. A tray according to claim 1, wherein at one, two, or three sides of the tray in directions of which the transport goods are not supported by the foldable support, a raised rim is provided which prevents the transport goods from slipping off in these directions.

15. A tray according to claim 1, wherein the basic element is made of plastics.

16. A tray according to claim 1, wherein the goods comprise beverage packs.

17. A tray according to claim 4, wherein the support includes an angle with the support surface of between 60° and 120°.

18. A tray according to claim 17, wherein the support includes an angle with the support surface of approximately 90°.

19. A tray according to claim 1 wherein the basic element is embodied in two parts, and the two parts are connected by a means for permitting movement of the two parts of the basic element about an axis, such that the support surface can be tilted with respect to a part of the basic element lying on the transport medium or another support surface.

20. A tray according to claim 1, wherein handles, indentations, hooks, or points of application for machines are provided at the basic element, wherein the handles, indentations, hooks, or points of application for machines facilitate manual or mechanical transport of the trays from and onto the transport medium or another support medium.
